(19) United States
(12) Patent Application Publication
(10) Pub. No.: US 2003/0135452 A1
(43) Pub. Date: Jul. 17, 2003

(54) Fully integrated SEC registration statement for the stock of a blank check company

(76) Inventors: John L. Petersen, Barbereche (CH); Rachel A. Fefer, Barbereche (CH); Jon David Washburn, Corinth, TX (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/317,453

(22) Filed: Dec. 12, 2002

Related U.S. Application Data
(60) Provisional application No. 60/340,241, filed on Dec. 12, 2001.

(51) Int. Cl. G06F 17/60

(52) U.S. Cl. 705/38; 705/35

(57) ABSTRACT

A method of registering the securities of a blank check company and implementing the related plan of operations. The disclosed methodology for a blank check company integrates the requirements of Securities and Exchange Commission Rule 415 and 419 with a registered offering that contemplates several classes of sale transactions and provides an integrated framework for implementing a business combination transaction and providing appropriate disclosure to all stockholders.

### CROSS-REFERENCE TO RELATED APPLICATIONS.

This application claims the benefit of U.S. Provisional Application No. 60/340,241, filed Dec. 12, 2001.

### BACKGROUND OF THE INVENTION

This invention relates to a business method for the preparation of a fully integrated registration statement under the Securities Act of 1933, as amended (Securities Act) for the stock of a blank check company and the implementation of the business methods and plan of operations described in the registration statement.

Most private companies that decide to go public do so because they need to raise additional capital for existing operations or corporate expansion. Nevertheless, the need for financing is not the only reason that private companies decide to go public.

A more fundamental issue is the overall impact of the going-public transaction itself on total stockholder value. In optimal cases where 100% ownership can be transferred to the purchaser, an established privately held company would ordinarily be valued at three to six times its annual earnings. If a majority stockholder wants to sell less than a 100% interest in a privately held company, the earnings multiple is usually discounted significantly. In the absence of a carefully articulated “exit strategy” for investors, it is almost impossible to sell a minority interest in a privately held company to a third-party who does not already have an ownership interest in that company.

In comparison, the stock of an established publicly-held company will ordinarily trade at a value of 12 to 24 times annual earnings, and the multiple may be significantly higher. In a public company context, the price/earnings multiple is ordinarily based on a fundamental assumption that an open market transaction will involve the sale of an insignificant minority interest. In cases where a larger interest is to be sold, the transaction will ordinarily occur at either a premium or a discount to the established price/earnings multiple based on a variety of factors.

Due to the historical differences between private and public company valuations, “going-public” transactions, as a class, create higher percentage gains for existing stockholders than any other class of corporate transactions. Going-public transactions, which can ordinarily be completed over a period of six to nine months, usually generate a 300% to 500% increase in total stockholder value and in many cases; the percentage gains are much higher. In all but the most extraordinary situations, it would take years for an established private company to generate comparable increases in total stockholder value.

Other important factors that frequently influence a private company's decision to go public include: providing investment liquidity for stockholders; facilitating equity-based compensation, facilitating retirement planning and management succession; facilitating estate planning by establishing a “market value” for a company; preparing a foundation for future equity and/or debt financing; and, creating an “alternative currency” (i.e., publicly traded shares) that can be used for acquisitions.

Why Would a Private Company Consider a Shell Transaction?

In cases where the primary motivating factor is a current need for additional capital, a traditional IPO is almost always preferable to a business combination with an existing public shell. In other cases, a business combination with an existing public shell may be an attractive alternative. The following paragraphs highlight some of the principal differences between an IPO and a business combination with an existing shell.

Financing Proceeds. An IPO usually generates substantial cash proceeds. Business combinations do not usually generate substantial cash proceeds.

Impact of Market Trends. The IPO market can be very “trendy” and if a company is not in a “hot” industry it can be difficult or impossible to conduct an IPO. The business combination market is frequently less concerned with current trends.

Development of Secondary Markets. After an IPO secondary trading markets develop rapidly, the markets are generally liquid and there is usually a good balance between sellers and buyers. After a business combination, secondary trading markets develop more slowly, liquidity is frequently a problem and there are often more sellers than buyers.

Sensitivity to Market Conditions. The IPO market is very sensitive to market conditions and underwritten offerings are frequently aborted or delayed at a relatively late stage in the process. The business combination market has less sensitivity to current market conditions and transactions are less likely to be aborted or delayed in their final stages.

Level of Public Visibility. The IPO market has a high degree of visibility, and companies that complete an IPO find it relatively easy to develop “institutional” interest in their stock. The business combination market has relatively low visibility and companies frequently find it more difficult to develop “institutional” interest in their stock.

Perception of Value. Because of the intense competition and extensive due diligence associated with the IPO process, companies that complete an IPO are frequently perceived as more substantial and credible. Companies that engage in business combination transactions are generally viewed with skepticism for an extended period of time.

What are the Principal Value Considerations in Evaluating Public Shells?

The generic term “public shell” can be used to describe any existing company that (a) has no substantial ongoing business activities, (b) has a relatively large stockholder base, and (c) has outstanding stock that may be lawfully resold by the existing stockholders in the public securities markets. Within this broad definition, there are substantial variations in the structure, value and overall utility of public shells. The principal factors that are typically considered when evaluating the overall utility and value of a particular shell include:

Control Status. Public shells that can offer a controlling interest to the owners of a private company are generally more desirable than shells that cannot implement a change in control.

Securities Act Registration. Public shells that have the ability effect a business combination by issuing stock that has been registered under the Securities Act are generally more desirable than shells that can only issue restricted stock.

Exchange Act Registration. Public shells that have registered their stock under the Securities Exchange Act of 1934, as amended (Exchange Act), are generally more desirable than shells that will be required to register with the Securitites and Exchange Commission (SEC or Commission) at some future date.

Trading Status. Public shells that are currently listed for trading or eligible for immediate listing are generally more desirable than shells that will be required to pursue a listing at a future date.

Available Resources. Public shells that have available resources, particularly cash resources, are generally more desirable than shells that have no available resources.

Prior Operations. Public shells that have no prior operations are generally more desirable than shells that have prior operations and the potential for contingent liabilities.

Stock Distribution. Public shells that have a substantial number of existing stockholders and a relatively even distribution of stock ownership are generally more desirable than shells that have a small number of stockholders, or a few stockholders who control large blocks of stock.

What is a “Blank Check Company?”

A blank check company is a development stage company that has no specific business plan or purpose, or has indicated its business plan is to engage in a merger or acquisition with an unidentified company or companies, other entity, or person. The term “Blank Check Company” is a statutory concept embodied in Section 7(b) of the Securities Act, which provides as follows:

(1) The Commission shall prescribe special rules with respect to registration statements filed by any issuer that is a blank check company. Such rules may, as the Commission determines necessary or appropriate in the public interest or for the protection of investors

(A) require such issuers to provide timely disclosure, prior to or after such statement becomes effective under section 8, of (i) information regarding the company to be acquired and the specific application of the proceeds of the offering, or (ii) additional information necessary to prevent such statement from being misleading;

(B) place limitations on the use of such proceeds and the distribution of securities by such issuer until the disclosures required under subparagraph (A) have been made; and

(C) provide a right of rescission to shareholders of such securities.

(2) The Commission may, as it determines consistent with the public interest and the protection of investors, by rule or order exempt any issuer or class of issuers from the rules prescribed under paragraph (1).

(3) For purposes of paragraph (1) of this subsection, the term “blank check company” means any development stage company that is issuing a penny stock (within the meaning of section 3 (a)(51) of the Securities Exchange Act of 1934) and that

(A) has no specific business plan or purpose; or

(B) has indicated that its business plan is to merge with an unidentified company or companies.

Reduced to fundamentals, a blank check company is any corporation that intends to conduct or has already conducted a registered public offering of securities for the principal purpose of creating a publicly held corporate shell that will attempt to enter into a business combination with a private company.

What Motivates the Principal Parties to a Blank Check Company Transaction?

The principal goals of the various classes of parties to a business combination transaction involving a blank check company are relatively simple to enumerate:

(1) The promoters of a blank check company hope to sell stock to investors and the owners of targets at a significantly higher price per share than the average price per share paid by them, thereby insuring significant gains when their stock is ultimately sold;

(2) The investors in a blank check company hope the promoters will be able to negotiate a business combination with a private company at a higher value per share than the average price per share paid by the investors;

(3) The private company that engages in a business combination with a blank check company hopes that (a) the nature of a blank check company will minimize the risk that the combined companies will be subject to undisclosed third-party liabilities (b) increases in the market value of its stock after the business combination will be sufficient to offset the interest in the combined companies that is retained by the existing stockholders of the blank check company, and (c) total stockholder value will increase significantly; and

(4) The stockholders of the private company hope that they will benefit from (a) increased investment liquidity, and (b) a market price for the public company shares that is significantly greater than the market price for their private company shares.

Introduction to Rule 419

In response to the mandate of Section 7(b), the SEC adopted Rule 419, which requires blank check companies to implement certain safekeeping, disclosure and reconfirmation procedures in their public offerings, including:

(1) Depositing at least 90% of the subscription proceeds in escrow for the sole benefit of investors until the requirements of Rule 419 have been satisfied and an acquisition has been completed;

(2) Giving investors an opportunity to reconfirm their investment decision after reviewing a final prospectus that contains detailed disclosure on the proposed acquisition;

(3) Providing for the pro rata refund of escrowed funds to investors who do not reconfirm their subscriptions; and

(4) Providing for the automatic distribution of all escrowed funds if (a) an acquisition is not completed within 18 months, or (b) a specified percentage of investors do not reconfirm their subscriptions in writing.

Rule 419 was adopted by the SEC on Apr. 13, 1992 and became effective approximately 90 days later. The Rule applied to all registration statements pending on the effective date or filed after the effective date.

What are the Earlier Methods used in Rule 419 Offerings?

Since 1992, approximately 200 registration statements have been filed for blank check companies that wanted to conduct a public offering of securities pursuant to Rule 419. Referring now to FIGS. 1a and 1b, there is illustrated a flow chart of the offering, operating, and closing procedures that must be followed by a blank check company that proposes to conduct an offering of securities pursuant to the requirements of Rule 419. Those registration statements have included the following classes of securities:

(1) An original issuance of common stock for cash;

(2) In approximately 20% of the offerings, the registration statement also made provisions for an original issuance of stock purchase warrants and the registration of the underlying common stock; and

(3) In approximately 15% of the offerings, the registration statement also made provisions for the open market resale of stock held by the promoters after the completion of a business combination.

While a relatively small percentage of the existing registration statements provide for the open market resale of outstanding shares held by promoters, these resales have nothing to do with the plan of operations itself. It should also be noted that the prior registration statements for Rule 419 offerings uniformly fail to provide for:

(1) The registration of stock to be issued to promoters and consultants in compensatory transactions;

(2) The registration of stock to be issued to owners of a private company in connection with an acquisition transaction;

(3) The registration of outstanding stock to be transferred to owners of a private company in connection with an acquisition transaction; and

(4) A prohibition on the resale of outstanding shares by promoters without prior registration if the shares are not purchased by the owners of a private company.

How Do Earlier Methods Work Under Applicable Law?

The Securities Act is unique in American law in that it begins with a presumption of illegality. Under the Securities Act, every offer to sell a security and every sale of a security is illegal unless the offer and the sale are registered under the Securities Act, or affected pursuant to a specific statutory or regulatory exemption from registration. Unlike most fields of American law, the burden of proving the availability of a particular exemption is on the person claiming the benefit thereof. Simply stated, every offer to sell a security and every sale of a security is presumed to be illegal unless the seller has registered the transaction or can establish the availability of an exemption.

For the sake of administrative convenience, and in recognition of the fact that many issuer transactions involve multiple related offers and sales of securities, the Securities Act and the associated Rules frequently speak in terms of “offerings,” rather than individual offers and sales. But in the final analysis, the legality of a particular offering will be determined by evaluating the facts and circumstances surrounding the individual offers and the individual sales that constitute the offering. For an example, if an exempt offering is being made to residents of a single state, the existence of a single out-of-state purchaser will be sufficient to defeat the claim of exemption. Similarly, if an exempt offering is being made only to persons who meet certain suitability requirements, the existence of a single unsuitable investor will be sufficient to defeat the claim of exemption. Once a determination is made that an issuer has violated the law, the principal remedy is restitution. Therefore, if a violation occurs in connection with an exempt offering, the purchasers of the securities have the right to require the issuer to refund all of the offering proceeds, together with interest.

One of the most difficult areas in securities law is determining whether a series of offerings by the same issuer are to be evaluated individually, as separate offerings, or collectively, as parts of an integrated plan of financing.

The SEC's long-standing “integration doctrine” is described in Rule 502(a) and provides that two or more offerings by the same issuer may, depending on the facts and circumstances, be treated as a single integrated offering. Rule 502(a) also identifies the following factors as being important to a determination as to whether two or more offerings should be integrated: (a) whether the sales are part of a single plan of financing; (b) whether the sales involve the issuance of the same class of securities; (c) whether the sales have been made at or about the same time; (d) whether the same type of consideration is received by the issuer; and (e) whether the sales are made for the same general purpose.

The current state of the art in Rule 419 offerings is to attempt to separate the registered cash transaction from the business combination transaction, i.e., to treat the sale of stock to the public for cash, and the issuance of stock to acquire a private company as separate and distinct transactions. The current state of the art in Rule 419 offerings also separates the registered cash transaction from any compensatory transactions.

Under the integration doctrine, however, it is inherently problematic for a blank check company to (a) conduct a registered public offering of securities for cash and deposit 90% of the offering proceeds in escrow pending completion of a business combination transaction; (b) negotiate a business combination transaction in reliance on a claim of exemption and defer the closing until after the cash purchasers have received a detailed prospectus for a registered reconfirmation offering; and (c) provide information on the business combination transaction to the cash purchasers as a condition precedent to the lawful completion of the registered public offering. The risks associated with attempting to effect a valid exempt offering during a period of time when the issuer has an open and effective registration statement are simply too great.

A similar problem arises under the SEC's long-standing “general solicitation doctrine” which holds that the act of filing a registration statement constitutes a “general solicitation” of prospective purchasers that begins when the registration statement is filed and does not end until after the offering is completed or terminated.

Since substantially all of the available exemptions from registration include express prohibitions against general solicitation, the general solicitation doctrine is also inherently problematic for blank check companies.

What is needed, therefore, is a business method whereby the cash transactions, any compensatory transactions and the business combination transaction can be treated as a single integrated whole that is fully registered under the Securities Act.

### SUMMARY OF THE INVENTION

The present invention comprises a business method that will be disclosed in a registration statement for a blank check company and implemented after the effective date of the registration statement. This business method registers in advance each of principal classes of transactions that are likely to arise in connection with the capitalization of the blank check company and the implementation of its business plan. The disclosed business method for a blank check company integrates in a single registration statement (a) the registration of a sale of securities for cash; (b) the registration and sale of securities in connection with a business combination; (c) the registration and sale of securities in connection with compensatory transactions; and (d) the registration and resale of certain outstanding securities as an integral element of the blank check company plan of operations. The disclosed business method for a blank check company is fundamentally different from every prior registration statement filed on behalf of a blank check company.

### BRIEF DESCRIPTION OF THE DRAWINGS

For a more complete understanding of the present invention and the advantages thereof, reference is now made to the following description taken in conjunction with the accompanying drawings in which:

FIG. 1a illustrates a flow chart of the offering procedures that must be followed by a blank check company that proposes to conduct an offering of securities pursuant to the requirements of Rule 419;

FIG. 1b illustrates a flow chart of the operating and closing procedures that are typically followed by a blank check company during the period between the completion of its initial cash offering and the completion of its reconfirmation under Rule 419;

FIG. 2a illustrates a flow chart of the offering procedures that will be followed by a blank check company that proposes to conduct an offering of securities pursuant to both the requirements of Rule 419 and a disclosed embodiment;

FIG. 2b illustrates a flow chart of the operating procedures that will be followed by a blank check company that proposes to conduct an offering of securities pursuant to both the requirements of Rule 419 and a disclosed embodiment during the period between the completion of its initial cash offering and the completion of the reconfirmation offering; and

FIG. 2c illustrates a flow chart of the closing procedures that will be followed by a blank check company that proposes to conduct an offering of securities pursuant to both the requirements of Rule 419 and a disclosed embodiment.

### DETAILED DESCRIPTION OF THE INVENTION

The disclosed business method abandons the underlying premise of the prior art: that the cash offering; any compensatory transactions; the business combination and the resale of previously outstanding securities can be rationally treated as separate transactions. Accordingly, the disclosed business method treats the entire sequence of transactions as a single integrated whole and includes every share of stock that the company has issued in the past or intends to issue in the future in its registration statement.

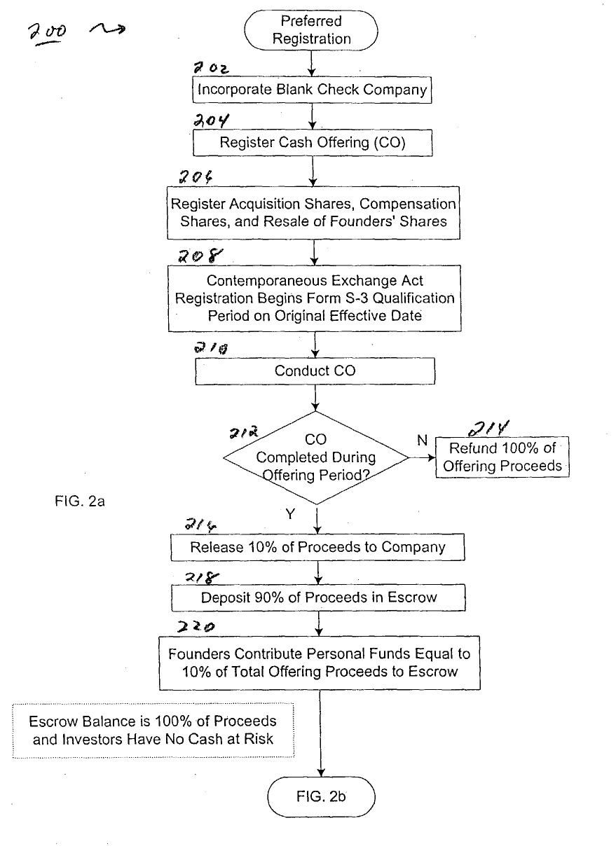

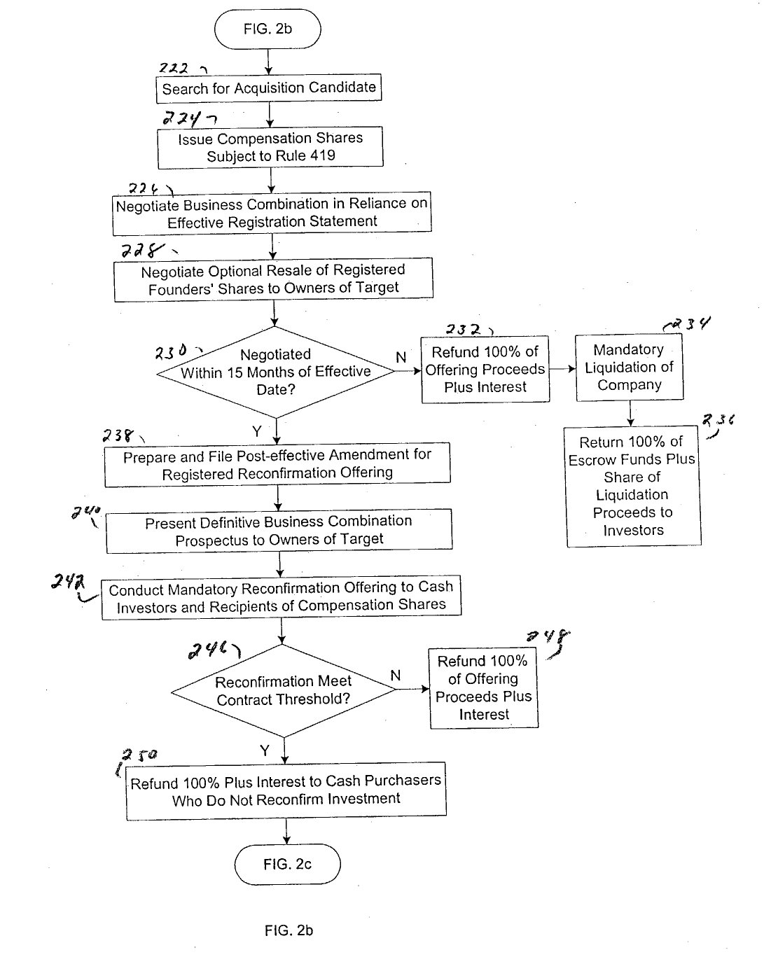

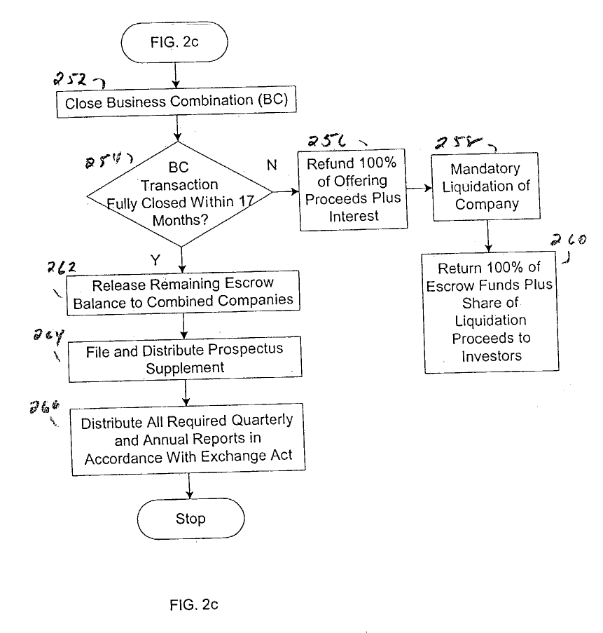

Referring now to FIGS. 2a, 2b, and 2c, there is illustrated a flow chart of the offering, operating, and closing procedures that will be followed by a blank check company that proposes to conduct an offering of securities pursuant to both the requirements of Rule 419 and a disclosed embodiment. The disclosed blank check company methodology views as a single integrated whole, the following series of transactions:

(1) The blank check company sells stock to the public for cash and deposits both the offering proceeds and the stock certificates in escrow until after its mandatory reconfirmation offering is completed;

(2) The blank check company agrees to issue shares of common stock to employees and advisors in compensatory transactions and deposits the stock certificates in escrow until after its mandatory reconfirmation offering is completed;

(3) The blank check company negotiates the terms of a business combination with a private company and defers the closing until after its mandatory reconfirmation offering is completed;

(4) The principal stockholders of the blank check company negotiate the optional resale of all or a substantial portion of their founders' shares in connection with a business combination and defer the closing of the transaction until after its mandatory reconfirmation offering is completed;

(5) The blank check company provides detailed pro forma disclosure on the business, management and finances of the combined companies to the stockholders of the private company, the original cash investors and the recipients of compensation shares; and

(6) After reviewing the detailed pro forma disclosure on the business, management and finances of the combined companies, the cash investors have the right to either remain investors or demand the return of their escrowed funds.

The disclosed registration statement is based upon the fundamental premise that the prior art in the field of blank check companies is inherently flawed and presents unreasonable and irreconcilable risks for promoters, investors, private companies and the owners of private companies because it attempts to (a) separate the cash offering from the business combination transaction, in contravention of the integration doctrine, and (b) effect a valid exempt offering during a period of time when the issuer has an effective registration statement outstanding, in contravention of the general solicitation doctrine.

The disclosed business method is the result of a long-term effort to understand and balance the needs of promoters, investors, private companies and the owners of such companies, and to provide a fully transparent framework for an integrated series of related transactions. Accordingly, the registration statement is a radical departure from the prior art.

The Technical Elements

The following sub-sections address the individual technical elements of the preferred embodiment of the disclosed business method, plan and structure.

Securities Registered. The preferred embodiment registers every share of stock that has been or will be issued by the blank check company prior to the completion of its mandatory reconfirmation offering and the final closing of a business combination transaction, specifically:

Cash Offering Shares. All shares that will be sold to the public for cash are included in the registration statement. This registration of the cash offering is the only feature of the preferred embodiment that exists in the prior art.

Founders' Shares. All shares that were issued by the blank check company before the filing of its registration statement are registered for resale by the holders, but only in connection with the negotiation of a business combination transaction. Any founders' shares that are not sold in connection with a business combination will be removed from registration in connection with the reconfirmation offering. This special purpose registration of founders' shares gives the founders of the blank check company an opportunity to recover their costs and generate an up-front profit on the transaction, while giving the stockholders of the target company an opportunity to significantly increase their ultimate ownership interest in the combined companies. The special purpose registration of founders' shares also (a) insures full and fair disclosure of the payments received by persons who may be deemed to be “promoters,” and (b) prevents the promoters from freely selling their shares into the market after the completion of a business combination.

Compensation Shares. All shares that will be issued by the blank check company in compensatory transactions are included in the registration statement. However, any compensation shares that are issued to officers and directors of the issuer and persons who receive more than 5% of the compensation shares will be removed from registration in connection with the reconfirmation offering. This special purpose registration of compensation shares gives the blank check company an opportunity to issue stock in exchange for necessary services, thereby increasing the cash resources available to the combined companies. It also prevents the promoters from freely selling any compensation shares they may receive into the market after the completion of a business combination.

Acquisition Shares. All shares that will be issued by the blank check company in connection a business combination transaction are included in the registration statement. While shares issued to officers, directors and certain affiliates of the private company will be subject to regulatory restrictions on resale, this registration of acquisition shares gives the blank check company the ability to provide immediate liquidity to the small stockholders of a private company in connection with a business combination.

Protection for Cash Investors. The preferred embodiment incorporates three unique elements that increase the level of protection to cash investors, specifically:

Founders' Contribution to Rule 419 Escrow. Rule 419 allows a blank check company to use 10% of the offering proceeds to fund its operations. Therefore, the cash investors are placing 10% of their investment funds at risk in the venture before they know what the ultimate business of the blank check company will be. To eliminate this risk, the preferred embodiment requires the promoters to make additional cash contributions to the escrow in an amount equal to the 10% of the offering proceeds that are released to the blank check company. As a result, the initial balance of the escrow will equal the total proceeds of the offering and the cash investors will have no funds at risk in the venture until they receive a detailed prospectus for the reconfirmation offering and elect to reconfirm their investment.

Dual-Stage Stock Purchase. The interplay between state law and Rule 419 makes it theoretically possible for (a) the blank check company to sell stock to cash investors at the stated offering price, (b) the blank check company to deposit 90% of the offering proceeds in escrow for the benefit of investors, and (c) subsequent creditors of the blank check company to claim a priority right to the escrowed funds under state law. To eliminate this possibility, the preferred embodiment includes provisions for a dual-stage sale of the blank check company's stock. The first stage of the stock purchase is affected for a consideration that equals or exceeds the par value of the shares, but only equals 10% of the stated offering price. The second stage of the stock purchase occurs when a cash investor reconfirms his investment and agrees to release his proportional share of the escrowed funds to the combined companies. Since the blank check company is not the owner of the escrowed funds until after the completion of the reconfirmation offering and the closing of a business combination, the escrow funds will not be subject to creditors claims until after the completion of the reconfirmation offering.

Mandatory Liquidation. The interplay between state law and Rule 419 makes it theoretically possible for a promoter to (a) organize a blank check company, (b) sell stock to the public for cash, (c) transfer 10% of the total offering proceeds to the blank check company as a capital contribution, (d) take no further action to implement the blank check company's business plan, and (e) rely on the express provisions of Rule 419 to force the cancellation of the stock sold to cash investors when the funds on deposit in escrow are refunded to the cash investors. In such an event, the promoter could theoretically take 10% of the total offering proceeds for his personal use without providing any potential benefit to the cash investors. To eliminate this possibility, the preferred embodiment includes provisions for the mandatory liquidation of the blank check company if a transaction is not negotiated within 15 months of the original effective date, or if a transaction is not closed within 17 months of the original effective date. In the event of such a mandatory liquidation, the cash investors will receive both (y) the funds on deposit in escrow, and (z) their proportional share of any remaining assets of the blank check company.

Protection for the Private Company. The preferred embodiment incorporates four unique elements that increase the level of protection to a private company, specifically:

Minimum and Maximum Purchase Limitations. A common problem associated with shell transactions is the possibility that a relatively small number of stockholders will own an inordinately high percentage of the public float (i.e. shares that can be freely resold in the secondary market). In such an event, a small number of stockholders could manipulate the market price by either withholding their shares from the market to artificially increase prices, or by dumping shares into the market to artificially depress prices. To minimize this possibility, the preferred embodiment includes limitations in the plan of distribution that require cash investors to purchase a minimum of 1,000 shares and prohibit cash investors from purchasing more than 10,000 shares. By creating arbitrary ownership limits, the preferred embodiment permits a blank check company to achieve a relatively even share distribution and prevent an untoward a concentration of power in the hands of a small number of stockholders.

Limitations on Resale. A second common problem associated with shell transactions is the likelihood that a relatively small number of purchasers will ordinarily be responsible the bulk of the stock purchases in a developing secondary market. History has shown that the number of stockholders of record typically declines rapidly as a secondary market develops. This fact can frequently create problems when the combined companies seek a listing on the NASDAQ market or other stock exchange because such markets ordinarily require a minimum number of public stockholders as a condition of listing. To eliminate this possibility over the short term, the preferred embodiment includes provisions that require cash purchasers and the recipients of compensation shares to retain ownership of at least 100 shares until the earlier of (a) 6 months after the closing of a business combination, or (b) the listing of the shares of the combined companies on NASDAQ. To implement the foregoing restriction, the preferred embodiment authorizes the blank check company to issue two stock certificates to each stockholder, one for 100 shares and a second for the balance of the shares. In the preferred embodiment, the certificate for 100 shares will be imprinted with a restrictive legend that describes the applicable limitations on transfer.

Resale Restrictions on Compensation Shares. A third common problem with shell transactions arises when shares are issued as compensation. In these cases, the recipients of the compensation shares have a marked tendency to resell their shares rapidly, and often without adequate regard to market conditions. To prevent recipients of compensation shares from acting in a manner that would be likely to have an adverse impact on the market for the stock of the combined companies, the preferred embodiment contains trading restrictions that prohibit such holders from (a) paying any portion of the proceeds from the resale of the compensation shares to the combined companies or their affiliates, (b) engaging in activities that promote or maintain a market for the stock, (c) engaging in “buy-side” trading activities, hedging transactions or other activities that could reasonably be expected to influence the market, (d) selling shares at a discount to the quoted bid price, (e) engaging in multiple sales during a 5-day period where the selling price is less than the previous price received, or (f) selling more than 10% of their original holdings in any calendar month.

Prohibition on Resale by Promoters. A fourth common problem that arises in connection with a shell transaction is the ability of the promoters to control or significantly influence the market price by their trading behavior. To prevent market manipulation by the promoters, the preferred embodiment provides that (a) founders shares retained by the promoters and (b) compensation shares issued to the promoters will be removed from registration on the effective date of the prospectus for the reconfirmation offering. These limitations effectively exclude the promoters from the market for a period of one year after the closing date unless the blank check company elects to file a registration statement for the resale of the promoters' shares. After the expiration of the first year, the promoters' ability to resell their shares without registration will be subject to normal resale rules for similar unregistered securities.

Unique Disclosures. The preferred embodiment permits two unique disclosure elements that improve the quality of information provided to prospective investors and facilitate well-reasoned investment decisions, specifically:

Acquisition Plan. In the prior art, it was impossible for a cash investor to know what the potential future capital structure of the blank check company would be. Since the preferred embodiment specifies the maximum number of shares that can be issued and specifies the conditions under which shares can be issued or transferred, it is possible for the prospectus to provide an easily understandable disclosure of the potential future capital structure of the combined companies, substantially in a following exemplary format:

“In addition to the shares that will be offered to investors for cash, we have included the following shares in our registration statement to facilitate a business combination:

12,500,000 acquisition shares that we will offer to issue to the owners of a target in connection with a business combination;

1,500,000 founders' shares that our current stockholders will offer to sell to the owners of a target in connection with a business combination; and

500,000 compensation shares that we will issue to our officers, directors and advisors as payment for managing our affairs, identifying a potential target and negotiating a business combination.

The following table provides summary forward-looking information on the potential future ownership of our company assuming that (a) all of the compensation shares are issued to our current officers and directors, (b) all of the acquisition shares are issued in connection with a business combination, and (c) all of the founders' shares are sold to the owners of a target.

| | | Stock | Potential | |
|---|---|---|---|---|
| | Original | issuance | future | Percent |
| | holdings | and (sales) | ownership | of total |
| Current Officers and | | | | |
| Directors | | | | |
| Founders' shares | 1,500,000 | | | |
| outstanding | | | | |
| Resale of founders' | | (1,500,000) | | |
| shares | | | | |
| Compensation | — | 500,000 | 500,000 | |
| shares issued | | | | |
| Total | 1,500,000 | (1,000,000) | 500,000 | 3.33% |
| Investors in this | — | 500,000 | 500,000 | 3.33% |
| offering | | | | |
| Owners of the target | | | | |
| Purchase of | — | 1,500,000 | 1,500,000 | |
| founders' shares | | | | |
| Acquisition shares | — | 12,500,000 | 12,500,000 | |
| issued | | | | |
| Total | | 14,000,000 | 14,000,000 | 93.33% |
| Shares outstanding | | | 15,000,000 | 100.00%” |
| after business | | | | |
| combination | | | | |

While the actual numbers and ratios may be modified to fit the specific needs of a particular blank check company, and therefore present only one potential embodiment of the concept, the ability to define the outer limits of future capital structure is unique.

Dilution. In the prior art, dilution was calculated by (1) calculating the net tangible book value per share prior to the offering, (2) adding the net offering proceeds to the net tangible book value of the blank check company in order to determine net tangible book value after the offering, and (3) dividing the net tangible book value of the blank check company after the offering by the number of shares then outstanding to determine the net dilution to the cash investors. Since the preferred embodiment (a) requires the founders to make an additional contribution to the escrow, (b) provides for a dual-stage stock purchase, and (c) protects the funds in the escrow from the claims of creditors, it is possible for the prospectus to provide an easily understandable dilution disclosure, substantially in the following format:

“The requirements of Rule 419 and the particular terms of this offering increase the complexity of our dilution calculation. A total of $12,500 in subscription proceeds will be deposited in the Rule 419 escrow on the closing date, together with any interest earned during the offering period. Concurrently, our founders' will contribute $12,500 of their personal funds to the Rule 419 escrow. Thereafter, the amount on deposit in the Rule 419 escrow on any given date will equal the sum of (a) $112,500 in subscription proceeds, (b) $12,500 contributed by our founders, and (c) the interest earned on the escrow funds. Therefore, the amount available for distribution to investors will equal or exceed the proceeds of this offering until we complete our reconfirmation offering and all of the business risk will be borne by our founders. When we negotiate a business combination and complete our reconfirmation offering, the bulk of the business risk will shift to the investors. The following table illustrates the dilution to investors (a) upon completion of this offering and (b) upon completion of our reconfirmation offering:

| | After Cash | | After | |
|---|---|---|---|---|
| | Offering (1) | | Reconfirmation (1)(2) | |
| | Total | Per Share | Total | Per Share |
| Offering price per share | | $0.25 | | $0.25 |
| Net tangible book value | $45,000 | $0.03 | $45,000 | $0.03 |
| before cash offering | | | | |
| Increase (Decrease) | 12,500 | ($0.01) | 12,500 | ($0.01) |
| attributable to cash | | | | |
| offering | | | | |
| Increase attributable to | — | — | 125,000 | $0.05 |
| reconfirmation offering | | | | |
| Pro forma net tangible | $57,500 | $0.02 | $182,500 | $0.07 |
| book value | | | | |
| Rule 419 rescission | $125,000 | $0.25 | | — |
| rights of investors | | | | |
| Total net tangible book | | $0.27 | | $0.07 |
| value of investment | | | | |
| Benefit (Dilution) to | | $0.02 | | ($0.18) |
| investors | | | | |

(1) The net tangible book value per share is based on 2,500,000 shares issued and outstanding, both after the offering and after the reconfirmation offering.
(2) The after reconfirmation values do not give effect to (a) interest on the Rule 419 escrow, (b) assets acquired in connection with a business combination, or (c) shares issued in connection with a business combination.”

While the actual numbers and ratios may be modified to fit the specific needs of a particular blank check company, and therefore present only one potential embodiment of the concept, the ability to accurately describe dilution both after the cash offering and after the reconfirmation offering is unique.

The Anticipated Benefits

The following sub-sections address the specific economic benefits to promoters, investors, private companies and the owners of private companies that are expected to flow from the implementation of the preferred embodiment of the disclosed business method, plan and structure.

Promoters. The principal goal of any promoter is to earn a profit for his investment of time, effort and money. And the promoter's job is a difficult one. Much like the old story of “Stone Soup” that many heard as children, the promoter has to bring together the money, talent and business fundamentals required for a successful public company. And he has to find a way to fairly and transparently compensate all of these elements.

In a typical blank check company transaction, the promoter will want to be compensated two ways. He will want an up-front cash payment to cover his costs of doing business. And he will want a back-end equity interest that permits him to share in the upside potential of a successful deal. He will also want the ability to divide his up-front and back-end compensation among the various members of his group to reflect the relative value of their individual contributions to the overall promotional effort.

Up-front Cash. There are only three ways for the promoter of a blank check company to receive an up-front cash payment. He can (a) demand that the blank check company pay a cash fee, (b) demand that the target pay a cash fee, or (c) sell a portion of his stock in the blank check company to the owners of the target for cash. Each of these methods of obtaining up-front cash has its own set of advantages and disadvantages. The following Table 1 attempts to summarize the principal advantages and disadvantages of each alternative in a logical format.

TABLE 1
Comparison of Up-Front Cash Sources

| Source | | |
|---|---|---|
| of Up-Front Cash | Advantages | Disadvantages |
| Company pays cash | Full up-front disclosure | Difficult to structure and |
| fee | | explain |
| | Readily determinable | No opportunity for |
| | amount | negotiation |
| | | Based on inflexible |
| | | formulas |
| | | Not necessarily “results |
| | | oriented” |
| | | Significantly reduces |
| | | available cash |
| Target pays cash fee | True arm's-length | Limited up-front |
| | negotiation | disclosure |
| | Transaction specific | Mandatory deal point |
| | amount | that significantly reduces |
| | | available cash |
| | Complete flexibility in | Immense potential for |
| | amount | conflicts of interest or |
| | | breach of fiduciary duty |
| Owners of target | True arm's-length | Limited up-front |
| purchase stock | negotiation | disclosure |
| | Optional deal point | |
| | Completely flexible | |
| | transaction specific | |
| | amount | |
| | Does not reduce | |
| | available cash | |
| | Reduced potential for | |
| | conflicts of interest or | |
| | breach of fiduciary duty | |

After considering the various alternatives, the most sensible approach is the sale of all or a portion of the promoter's original ownership interest to the owners of a target for cash. In this case, the blank check company is not obligated to pay specific and inflexible fees to the promoters and the promoters have no ability to arbitrarily establish the terms of their cash compensation. Likewise, the target is not obligated to pay any fees to the promoters and the promoters have a reduced ability to increase their cash compensation at the expense of the investors. In addition, the cash in the blank check company and the financial resources of the target remain available to finance the operations of the combined companies. Finally, the sale of stock for cash by the promoter(s) is a completely optional deal point that can be tailored to fit the particular needs of the specific parties to an actual transaction. If the promoter is presented with a situation where the upside potential of the back-end interest is more valuable to him than the up-front cash, he can elect to reduce his up-front payment and retain a larger back-end interest. In effect, the only limitation on deal structure is the creativity of the promoter and the owners of the target.

Thus the sale of stock for cash by the promoters provides a clearly identifiable benchmark by which the fairness of the overall transaction may be evaluated. If the promoters, for example, receive a cash price of $1 per share and the value of the property received by the blank check company is only $0.50 per share, then there is clear evidence that the promoters have breached their fiduciary duties to the public investors. Since cash is inherently easier to value than property, and since hindsight is always more accurate than foresight, it would be foolish to negotiate a transaction where the cash value received by the promoters was more than approximately 50% of the property value received by the blank check company.

To facilitate the sale of a portion of the promoter's interest in order to generate up-front cash, the disclosed method statement includes all of the shares that were purchased by the promoters in connection with their organization of the company. These shares may only be sold to the owners of a target in connection with a business combination. If the shares are not sold in connection with a business combination, the shares must be removed from registration and may not thereafter be sold by the promoters in the absence of registration under the Securities Act, or an exemption from registration that has been specifically discussed in advance with the staff of the SEC.

For example, under the disclosed registration statement, a total of 2,500,000 shares will be outstanding after the sale of 500,000 shares to investors and the issuance of 500,000 compensation shares. The maximum number of shares that can be issued by the company in connection with an acquisition is 12,500,000. Therefore, if the owners of a target do not purchase any of the founders' shares, their maximum potential interest in the combined companies will be 83.33%. If, on the other hand, the owners of the target purchase all of the founders' shares, their maximum potential interest in the combined companies may be as high as 93.33%.

Back-end Equity. Continuing with the example, the disclosed methodology provides a registration statement that includes a total of 500,000 compensation shares for issuance to the promoters and their consultants in connection with the completion of a transaction. These shares are intended to constitute the bulk of the promoters' back-end equity interest. Subject to certain limitations, these shares may be allocated to anyone who performs material services in connection with the transaction and the number of shares allocated to each recipient is limited only by the discretion and judgment of the promoters. The only fixed feature of the compensation shares is the allocation of the residue among the four principal participants. This fixed allocation of the compensation shares has four important benefits:

(1) It establishes a fixed and determinable back-end equity interest for the promoter group that can be readily evaluated by prospective cash investors before they make an investment decision;

(2) It minimizes the potential for conflict within the core promoter group based on divergent views of who made what contribution to the overall success of the venture;

(3) It minimizes the potential that the SEC could assert that the compensation shares were issued as commissions or other remuneration for effecting transactions in securities; and

(4) It gives the promoters a limited ability to increase the number of stockholders in order to satisfy market listing requirements.

Investors. The principal goal of the investors in a blank check company is to buy shares for a lower price than the anticipated future market value of those shares. In substance, the cash investors hope to piggyback on the talents and efforts of the promoters in exchange for assuming a specific risk of loss. In general, investors want to minimize their risk of loss and maximize their potential gains.

The disclosed methodology includes a registration statement having three unique features that minimize or eliminate the front-end risk exposure of investors, including:

(1) A split purchase price for shares consisting of (1) a fixed consideration of $0.025 per share that will be paid to the company immediately and (2) a reconfirmation consideration equal to the per share balance of the Rule 419 escrow that will only be payable to the company upon the successful completion of the reconfirmation offering;

(2) A mandatory corporate liquidation that becomes operative before the mandatory refund provisions of Rule 419 become operative; and

(3) A founders' contribution to the Rule 419 escrow in an amount sufficient to provide for a complete refund of the original subscription price paid by investors.

The split purchase price feature insures that the funds in the Rule 419 escrow will not be an asset of the company, and will not be subject to creditors' claims, until after the completion of the reconfirmation offering. This element is a clear departure from the prior art because all of the prior art blank check company registration statements stated that the total price of the shares was the legal consideration for the issuance of the shares. Therefore, every other blank check company registration statement presented a material risk that third-party creditors could assert a priority claim to the funds on deposit in the escrow accounts.

Furthermore, in prior art blank check company registration statements, it was possible for corporate existence to continue beyond the date that the mandatory refund provisions of Rule 419 became effective. This raised the possibility that the blank check company could receive 10% of the subscription price, conduct no meaningful activities, and require the investors to surrender 100% of the shares they purchased in the offering in return for 90% of the subscription price paid. In that event, any assets remaining in the blank check company would automatically revert to the sole benefit of the promoters who had failed to negotiate an acceptable business combination.

In contrast, requiring the mandatory liquidation in accordance with the disclosed methodology prior to the effective date of the mandatory refund provisions of Rule 419, ensures that each investor will receive (1) his proportional share of any assets that remain on the liquidation date, and (2) his proportional share of the funds on deposit in the Rule 419 escrow.

Additionally, in conventional blank check company registration statements, 10% of the offering proceeds were immediately released to the blank check company for use in its business, and the remaining 90% of the offering proceeds were deposited in escrow. The disclosed methodology registration statement requires the promoters to make a cash contribution to the Rule 419 escrow equal to 10% of the total offering proceeds. Therefore, the amount on deposit in the Rule 419 escrow will always equal or exceed the total cash contributed by investors.

Private Companies. Private companies that are interested in pursuing a business combination with a public shell are principally concerned that (1) the shell's assets and liabilities are as represented, (2) there are no undisclosed or contingent liabilities, (3) the shell has a sufficiently large stockholder base to qualify for a NASDAQ listing, and (4) that the principal stockholders of the shell are restrained from dumping their shares into a developing market.

The registration statement of the disclosed methodology contains a number of unique features that minimize the risk to private companies, including:

(1) Full registration of all shares that have previously issued or intended to be issued, which minimizes the risk of undiscovered liabilities under the Securities Act;

(2) A plan of distribution that is designed to maximize the number of stockholders and provide for a relatively even distribution of stock ownership;

(3) A requirement that all investors and all recipients of compensation shares retain ownership of at least 100 shares until the earlier of 6 months after the closing of the business combination or the listing of the stock of the combined companies on NASDAQ;

(4) Novel contractual restrictions on the resale of compensation shares that define a code of conduct for persons who receive those shares; and

(5) An outright prohibition against the unregistered resale of shares held by affiliates of the company and persons who receive more than 25,000 compensation shares.

All of the above features that are intended to protect the private company are unique in the context of a Rule 419 offering.

Owners of Private Companies. The owners of private companies that are interested in pursuing a business combination with a public shell are principally concerned with the after market performance of the stock of the combined companies and the current or future marketability of the shares held by them. The registration statement of the disclosed methodology is the only Rule 419 offering to ever register the acquisition shares that the company will issue to the owners of a target. Therefore, it is the only Rule 419 offering that has the potential to give minority stockholders of a target immediate liquidity.

Conventional registration statements for a blank check company are based on the premise that the acquisition would be affected as a “private placement transaction” and all stockholders of the target would receive restricted securities, rather than registered securities. Since private placement transactions are ordinarily affected at a significant discount from “fair market value,” this feature of the disclosed registration statement methodology can increase the total value received by minority stockholders by up to 100%.

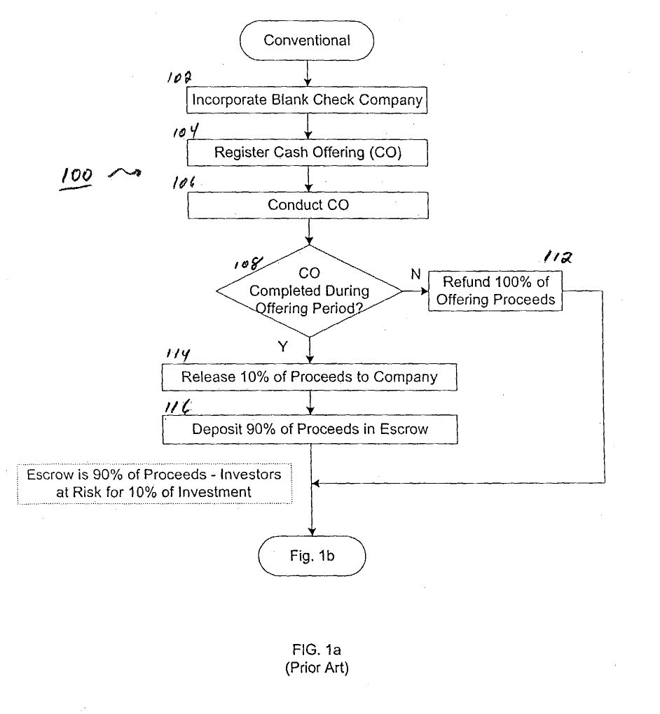

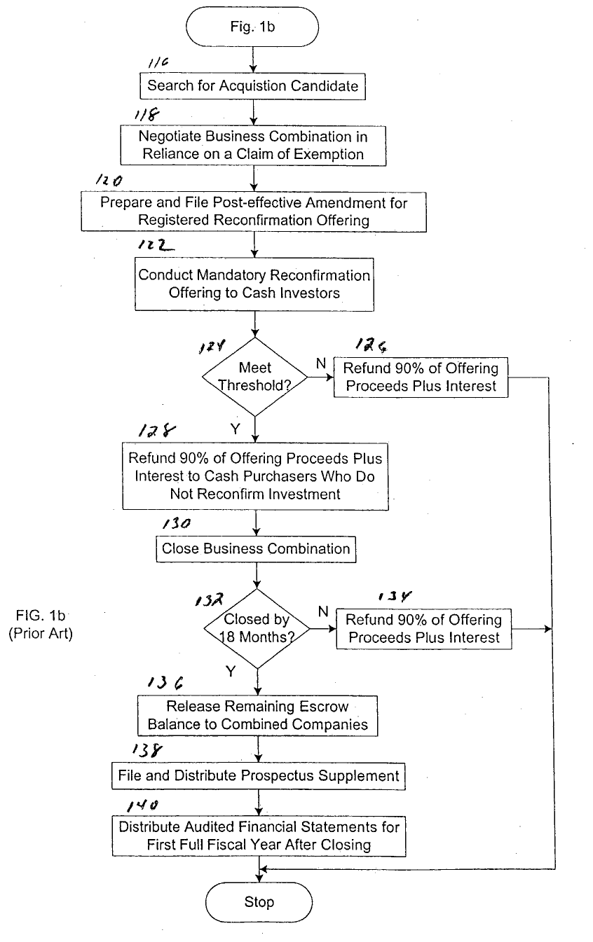

Referring now to FIGS. 1a and 1b, there is illustrated a flow chart 100 of the offering procedures of the prior art that must be followed by a blank check company that proposes to conduct an offering of securities pursuant to the requirements of Rule 419. At step 102 the Black Check company is incorporated. At step 104 the Cash Offering is registered. At step 106 the Cash Offering is conducted. Then at step 108 it is determined if the Cash Offering was completed during the offering period. If the cash offering was not completed, then 100% of the offering proceeds are refunded. If at step 108 it is determined that the cash offering was completed during the offering period, then processing continues to step 114 wherein 10% of the proceeds are released to the company, and then at step 116, which may be completed simultaneously to step 114, 90% of the proceeds are deposited in escrow. A search for an Acquisition Candidate is then conducted as shown at step 116. At step 118 a Business Combination in Reliance on a claim of exemption is negotiated. At step 120 a post-effective amendment for registered reconfirmation offering is prepared and filed. At step 112 the mandatory reconfirmation offering to cash inventors is conducted. At step 124 it is determined if the reconfirmation meets a threshold, if not then 90% of the offering proceeds plus interest are refunded. If at step 124 the threshold is met, then at step 128, the cash purchasers who do not reconfirm investment are refunded 90% of their offering proceeds plus interest. At step 130 the business combination is closed. At step 132 it is determined whether the combination was closed within 18 months, if not then as shown in step 134, 90% of the offering proceeds plus interest are refunded. If at step 132 it is determined the close occurred within 18 months, then as shown at step 136 the remaining escrow is released to the combined companies. At step 138 the prospectus supplement is filed and distributed. Then as shown in step 140, the audited financial statements for the first full fiscal year after closing are distributed.

FIGS. 2a, 2b and 2c illustrate a flow chart 200 of the offering procedures that will be followed by a blank check company that proposes to conduct an offering of securities pursuant to an embodiment of the present invention and Rule 419.

At step 202 the Blank Check Company is incorporated. At step 204 the cash offering is registered. At step 206 the acquisition shared, compensation shares, and resale of founder's shares are registered. At step 208 Contemporaneous Exchange Act Registration begins, Form S-3 Qualification period on the Original Effective Date. Then at step 210 the cash offering is conducted. At step 212 it is determined if the cash offering was completed during the offering period, if not then 100% of the proceeds are refunded as shown at step 214, otherwise processing continues at step 216 wherein 10% of the proceeds are released to the company and as shown at step 218, which may be done at the same time or interchangeably with step 216, 90% of proceeds are deposited in escrow. At step 220 the founders contribute personal funds equal to 10% of the total offering proceeds to escrow, therefore the escrow balance is 100% of the proceeds and the investors have no cash at risk.

At step 222 a search is made for an acquisition candidate. At step 224 compensation shares subject to Rule 419 are issued. The next steps are 226, is to negotiate business combination in reliance on effective registration statement, and then 228 to negotiate optional resale of registered founders' shares to owners of a target.

At step 230 it is determined whether negotiations are within 15 months of the effective date. If at step 230 negotiations are not with in 15 months of the effective date, then at step 232, 100% of the offering proceeds plus interest are refunded, at step 234 there is a mandatory liquidation of the company and at step 236 100% of the escrow funds plus share of the liquidation are returned to the investors. If at step 230 the negotiations were within 15 months of the effective date, then at step 238 the Post-effective Amendment for Registered Reconfirmation offering is prepared and filed. At step 240 the owners of the target are presented with a definitive business combination prospectus. At step 242 a mandatory reconfirmation offering is conducted to the cash investors and recipients of compensation shares.

At step 246 it is determined if the reconfirmation meets the contract threshold, if it does not then as shown at step 248, 100% of the offering proceeds plus interest are refunded, otherwise, as shown at step 250, 100% of the offering proceeds plus interest are refunded to cash purchasers who do not reconfirm investment.

At step 252 the business combination is then closed. At step 254 it is determined whether the business combination transaction was fully closed within 17 months. If not, then 100% of the offering proceeds plus interest are refunded., there is a mandatory liquidation of the company, and then 100% of the escrow funds plus share of liquidation proceeds are distributed to the investors.

If at step 254 it is determined that the business transaction fully closed within 17 months, then processing proceeds to step 262 wherein the remaining escrow balance is released to the combined companies, the prospectus supplement is filed and distributed at step 264, and all required quarterly and annual reports ni accordance with the Exchange Act are distributed at step 266.

Although the preferred embodiment has been described in detail above, it should be understood that various changes, substitutions and alterations could be made without departing from the spirit and scope of the invention.

What is claimed is:

1. A method of operating a blank check company, comprising the step of registering the blank check company such that a sale of securities for cash and a business combination are integrated into a single Rule 419 transaction.

2. The method of claim 1 wherein the single Rule 419 transaction further comprises a registration statement.

3. The method of claim 2 wherein the registration statement comprises a registration of a sale of a security for cash.

4. The method of claim 2 wherein the registration statement comprises a registration and sale of a security in connection with a business combination.

5. The method of claim 2 wherein the registration statement comprises a registration and sale of a security in connection with a compensatory transaction.

6. The method of claim 2 wherein the registration statement comprises a registration and resale of a certain outstanding security as an integral element of a blank check company plan of operations.

7. The method of claim 1 wherein the Rule 419 transaction comprises a sequence of transactions that are treated as a single integrated whole.

8. The method of claim 1 wherein the Rule 419 transaction includes at least one of the group consisting of every share of stock that the blank check company has issued in the past, and every share of stock that the blank check company intends to issue in the future in its registration statement.

9. A method for operating a blank check company, the steps comprising generating a single registration statement comprising:
a cash offering transaction;
a release of proceeds to the company;
a deposit of funds to escrow;
a negotiated business combination;
a reconfirmation offering;
a business close transaction; and
a distribution of all required quarterly and annual reports in accordance with legal requirements.

10. The method of claim 9 further comprising contributing personal funds equal to ten percent of the total offering proceeds to escrow by a founder.

11. The method of claim 9 wherein one hundred percent of offering proceeds plus interest is refunded to investors when the negotiated business combination takes longer than fifteen months to complete.

12. The method of claim 10 wherein a refund of one hundred percent of offering proceeds plus interest is distributed to inventors when the reconfirmation offering does not meet specified thresholds.

13. The method of claim 10 wherein a refund of one hundred percent of offering proceeds plus interest is distributed to inventors when the business close transaction is not completed within 17 months.

14. The method of claim 10, the steps further comprising registering acquisition shares, compensation shares and resale of founders' shares.
